(19) United States
(12) Patent Application Publication
(10) Pub. No.: US 2023/0315477 A1
(43) Pub. Date: Oct. 5, 2023

(54) COMPUTING APPARATUS, INTEGRATED CIRCUIT CHIP, BOARD CARD, ELECTRONIC DEVICE AND COMPUTING METHOD

(71) Applicant: CAMBRICON (XI'AN) SEMICONDUCTOR CO., LTD., Shaanxi (CN)

(72) Inventors: Xin YU, Shaanxi (CN); Shaoli LIU, Shaanxi (CN); Jinhua TAO, Shaanxi (CN)

(21) Appl. No.: 18/013,748

(22) PCT Filed: May 19, 2021
(86) PCT No.: PCT/CN2021/094724

§ 371 Date: Dec. 29, 2022

(30) Foreign Application Priority Data
Jun. 30, 2020 (CN) 202010618109.7

(51) Int. Cl. G06F 9/38

(52) U.S. Cl. CPC G06F 9/3867; G06F 9/3836

(57) ABSTRACT

A computing apparatus may be included in a combined processing apparatus. The combined processing apparatus may further include a general interconnection interface and other processing apparatus. The computing apparatus interacts with other processing apparatus to jointly complete a computing operation specified by a user. The combined processing apparatus may further include a storage apparatus. The storage apparatus is connected to the apparatus and other processing apparatus respectively. The storage apparatus is used to store data of the apparatus and other processing apparatus. Efficiency of various operations in data processing fields including, for example, an artificial intelligence field may be improved so that overall overheads and costs of the operations can be reduced.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/CN2021/094724 filed on May 19, 2021, which claims priority to the benefit of Chinese Patent Application No. 202010618109.7 filed in the Chinese Intellectual Property Office on Jun. 30, 2020, the entire contents of which are incorporated herein by reference.

### BACKGROUND

### 1. Technical Field

The present disclosure generally relates to a computing field. More specifically, the present disclosure relates to a computing apparatus, an integrated circuit chip, a board card, an electronic device, and a computing method.

### 2. Background Art

In a computing system, an instruction set is a set of instructions used to perform computing and control the computing system. Moreover, the instruction set plays a key role in improving performance of a computing chip (such as a processor) in the computing system. At present, various computing chips (especially chips in an artificial intelligence field), by using an associated instruction set, may complete various general or specific control operations and data processing operations. However, there are many defects in the existing instruction set. For example, limited by a hardware architecture, the existing instruction set performs poorly in flexibility. Further, many instructions may only complete a single operation, while performing multiple operations generally requires multiple instructions, potentially resulting in an increase in throughput of on-chip I/O data. Additionally, there is still improvement room for a current instruction in execution speed, execution efficiency and power consumption on the chip.

### SUMMARY

In order to at least solve problems in the prior art, the present disclosure provides a hardware architecture with a processing circuit array. By using the hardware architecture to perform a computing instruction, a solution of the present disclosure may achieve technical effects in multiple aspects including improving processing performance of hardware, reducing power consumption, improving execution efficiency of a computing operation, and avoiding computing overheads.

A first aspect of the present disclosure provides a computing apparatus, including: a processing circuit array, which is formed by connecting a plurality of processing circuits in a one-dimensional or multi-dimensional array structure, where the processing circuit array is configured to a plurality of processing circuit sub-arrays and in response to receiving a plurality of operation instructions, the processing circuit array performs a multi-thread operation, and each processing circuit sub-array is configured to perform at least one operation instruction in the plurality of operation instructions, where the plurality of operation instructions are obtained by parsing a computing instruction received by the computing apparatus.

A second aspect of the present disclosure provides an integrated circuit chip, including the computing apparatus described above and detailed in a plurality of embodiments below.

A third aspect of the present disclosure provides a board card, including the integrated circuit chip described above and detailed in a plurality of embodiments below.

A fourth aspect of the present disclosure provides an electronic device, including the integrated circuit chip described above and detailed in a plurality of embodiments below.

A fifth aspect of the present disclosure provides a method of using the aforementioned computing apparatus to perform computing, where the computing apparatus includes a processing circuit array, which is formed by connecting a plurality of processing circuits in a one-dimensional or multi-dimensional array structure. The processing circuit array is configured to a plurality of processing circuit sub-arrays. The method includes: receiving a computing instruction in the computing apparatus, parsing the computing instruction to obtain a plurality of operation instructions; and in response to receiving the plurality of operation instructions, using the plurality of processing circuit sub-arrays to perform a multi-stage pipeline operation, where each processing circuit sub-array in the plurality of processing circuit sub-arrays is configured to perform at least one operation instruction in the plurality of operation instructions.

By using the computing apparatus, the integrated circuit chip, the board card, the electronic device, and the method of the present disclosure described above, an appropriate processing circuit array may be constructed according to computing requirements, thus performing a computing instruction efficiently, reducing computing overheads, and decreasing throughput of I/O data. Additionally, since a processing circuit of the present disclosure may be configured to support a corresponding operation according to the operation requirements, the number of operands of the computing instruction of the present disclosure may be increased or decreased according to the operational requirements, and a type of an operation code may be selected and combined arbitrarily among operational types supported by a processing circuit matrix, thereby expanding the application scenario and compatibility of the hard architecture.

### BRIEF DESCRIPTION OF THE DRAWINGS

By reading the following detailed description with reference to drawings, the above and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIG. 1 is a block diagram of a computing apparatus according to a first embodiment of the present disclosure.

FIG. 2A is a block diagram of a computing apparatus according to a second embodiment of the present disclosure.

FIG. 2B is a block diagram of a computing apparatus according to a third embodiment of the present disclosure.

FIG. 3 is a block diagram of a computing apparatus according to a fourth embodiment of the present disclosure.

FIG. 4 is an exemplary structural diagram of a multi-type processing circuit array of a computing apparatus according to an embodiment of the present disclosure.

FIGS. 5A, 5B, 5C and 5D are schematic diagrams of multiple types of connections of a plurality of processing circuits according to embodiments of the present disclosure.

FIGS. 6A, 6B, 6C and 6D are schematic diagrams of other multiple types of connections of a plurality of processing circuits according to embodiments of the present disclosure.

FIGS. 7A, 7B, 7C, and 7D are schematic diagrams of multiple types of loop structures of processing circuits according to embodiments of the present disclosure.

FIGS. 8A, 8B, and 8C are schematic diagrams of other multiple types of loop structures of processing circuits according to embodiments of the present disclosure.

FIGS. 9A, 9B, 9C and 9D are schematic diagrams of a data concatenation operation performed by a pre-operating circuit according to embodiments of the present disclosure.

FIGS. 10A, 10B, and 10C are schematic diagrams of a data compression operation performed by a post-operating circuit according to embodiments of the present disclosure.

FIG. 11 is a simplified flowchart of a method of using a computing apparatus to perform an operation according to an embodiment of the present disclosure.

FIG. 12 is a structural diagram of a combined processing apparatus according to an embodiment of the present disclosure.

FIG. 13 is a schematic structural diagram of a board card according to an embodiment of the present disclosure.

### DETAILED DESCRIPTION

A solution of the present disclosure provides a hardware architecture that supports a multi-thread operation. When the hardware architecture is implemented in a computing apparatus, the computing apparatus at least includes a plurality of processing circuits, where the plurality of processing circuits may be connected according to different configurations, so as to form a one-dimensional or multi-dimensional array structure. According to different implementations, a processing circuit array may be configured to a plurality of processing circuit sub-arrays, and each processing circuit sub-array may be configured to perform at least one operation instruction in a plurality of operation instructions. By using the hardware architecture and the operation instruction of the present disclosure, a computing operation may be performed efficiently, application scenarios of computing may be expanded, and computing overheads may be reduced.

A technical solution in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those skilled in the art based on the embodiments of the present disclosure without creative efforts shall fall within the protection scope of the present disclosure.

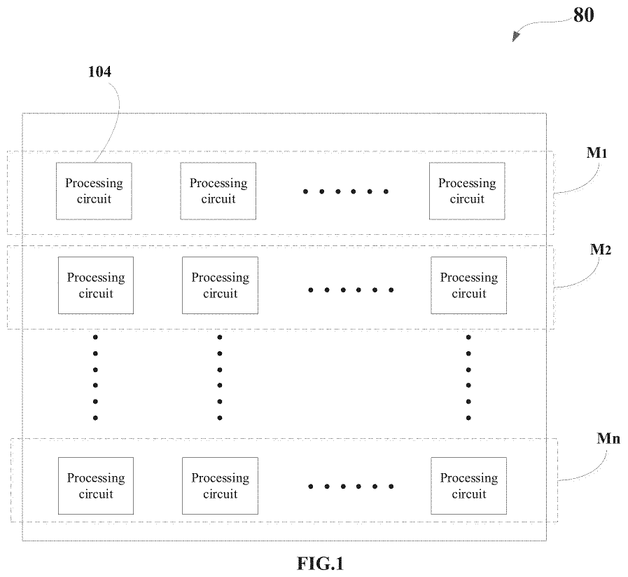

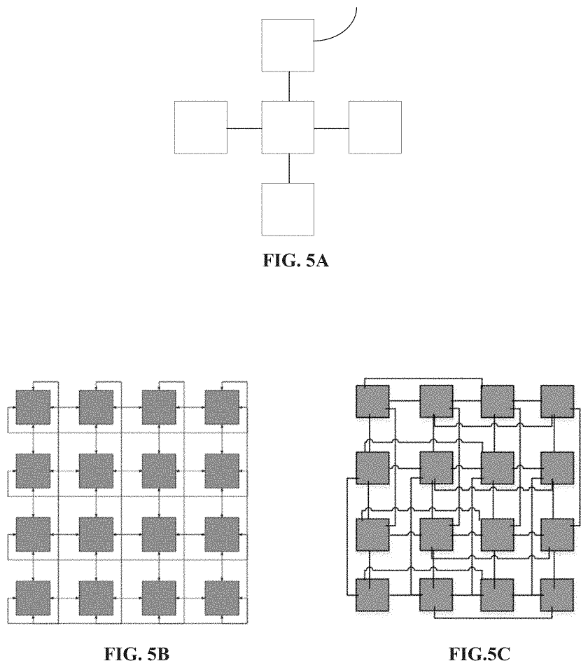

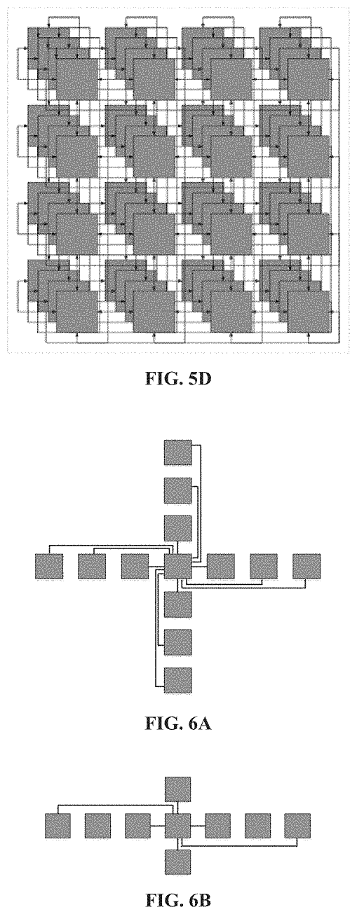

FIG. 1 is a block diagram of a computing apparatus 80 according to a first embodiment of the present disclosure. As shown in FIG. 1, the computing apparatus 80 may include a processing circuit array formed by a plurality of processing circuits 104. Specifically, the plurality of processing circuits are connected in a two-dimensional array structure to form the processing circuit array, and the processing circuit array includes a plurality of processing circuit sub-arrays, such as a plurality of one-dimensional processing circuit sub-arrays including M1, M2, . . . , Mn shown in the figure. It is required to be understood that here, the processing circuit array with a two-dimensional structure and the plurality of one-dimensional processing circuit sub-arrays included are only exemplary rather than restrictive. According to different operational scenarios, the processing circuit array of the present disclosure may be configured to an array structure with a different dimension, and within the processing circuit sub-array or between the plurality of processing circuit sub-arrays, one or a plurality of closed loops may be formed, such as exemplary connections shown in FIGS. 5A-8C described later.

In an embodiment, in response to receiving a plurality of operation instructions, the processing circuit array of the present disclosure may be configured to perform a multi-thread operation, such as performing a single-instruction multiple-thread (SIMT) instruction. Further, each processing circuit sub-array may be configured to perform at least one operation instruction in the plurality of operation instructions. In the present disclosure, the plurality of operation instructions mentioned above may be micro-instructions or control signals operated inside the computing apparatus (or a processing circuit, a processor), which may include (or may indicate) one or a plurality of operations that are required to be performed by the computing apparatus. According to different operational scenarios, the operations include but are not limited to various operations such as an addition operation, a multiplication operation, a convolution operation, and a pooling operation.

In an embodiment, the plurality of operation instructions mentioned above may include at least one multi-stage pipeline operation. In a scenario, the aforementioned one multi-stage pipeline operation may include at least two operation instructions. According to different execution requirements, the operation instruction of the present disclosure may include a predicate, and each processing circuit may judge whether to perform a related operation instruction according to the predicate. The processing circuits of the present disclosure perform various operations flexibly according to a configuration. The operations include but are not limited to an arithmetic operation, a logical operation, a comparison operation, and a lookup table operation.

Taking a case where the processing circuit matrix and M1˜Mn processing circuit sub-matrices included perform an n-stage pipeline operation shown in FIG. 1 as an example, a processing circuit sub-matrix M1 may be used as a first-stage pipeline operation unit in the pipeline operation, and a processing circuit sub-matrix M2 may be used as a second-stage pipeline operation unit in the pipeline operation. In a similar fashion, a processing circuit sub-matrix Mn may be used as an n-stage pipeline operation unit in the pipeline operation. During an execution process of the n-stage pipeline operation, starting from the first-stage pipeline operation unit, each stage of operation may be executed from top to bottom until the n-stage pipeline operation is completed.

Through the exemplary description of the processing circuit sub-array above, it may be understood that the processing circuit array of the present disclosure, in some scenarios, may be a one-dimensional array, and one or a plurality of processing circuits in the processing circuit array may be configured to serve as one processing circuit sub-array. In some other scenarios, the processing circuit array of the present disclosure may be a two-dimensional array, and one row or more rows of processing circuits in the processing circuit array may be configured to serve as one processing circuit sub-array; or one column or more columns of processing circuits in the processing circuit array may be configured to serve as one processing circuit sub-array; or one row or more rows of processing circuits along a diagonal direction in the processing circuit array may be configured to serve as one processing circuit sub-array.

In order to implement a multi-stage pipeline operation, the present disclosure may further provide a corresponding computing instruction, and based on the computing instruction, the processing circuit array may be configured and constructed, so as to implement the multi-stage pipeline operation. According to different operational scenarios, the computing instruction of the present disclosure may include a plurality of operation codes, and the operation code may represent a plurality of operations performed by the processing circuit array. For example, if n=4 (which means that a four-stage pipeline operation is performed) in FIG. 1, according to a solution of the present disclosure, the computing instruction may be expressed in a formula (1) as follows.

Result=convert((((scr0op0scr1)op1src2)op2src3)op3src4) (1).

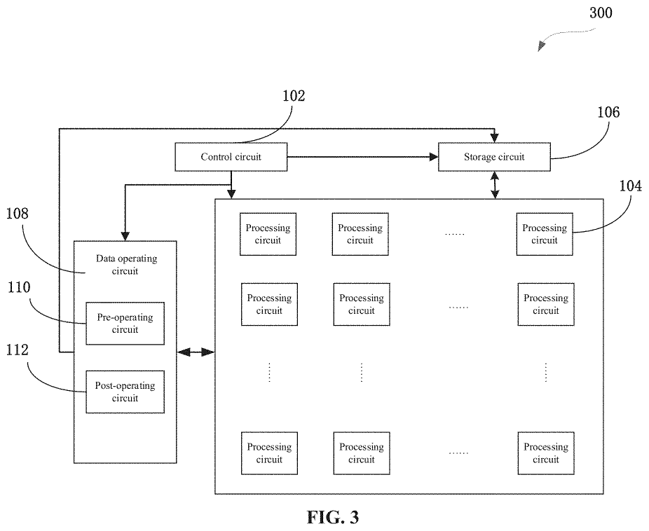

In this formula, scr0˜src4 are source operands, op0˜op3 are operation codes, and convert represents performing a data conversion operation on data obtained after performing an operation code op4. According to different implementations, the aforementioned data conversion operation may be completed by the processing circuit in the processing circuit array, or by another operating circuit, such as a post-operating circuit detailed later in combination with FIG. 3. According to the solution of the present disclosure, since the processing circuit may be configured to support a corresponding operation according to operational requirements, the number of operands of the computing instruction of the present disclosure may be increased or decreased according to the operational requirements, and a type of an operation code may be selected and combined arbitrarily among operation types supported by the processing circuit matrix.

According to different application scenarios, a connection between the plurality of processing circuits may be either a hardware-based configuration connection (or called a hard connection), or a logical configuration connection (or called a soft connection) based on a specific hardware connection through a software configuration. In an embodiment, the processing circuit arrays may be formed into a closed loop in at least one dimension direction of a one-dimensional or multi-dimensional direction, which is a loop structure in the present disclosure.

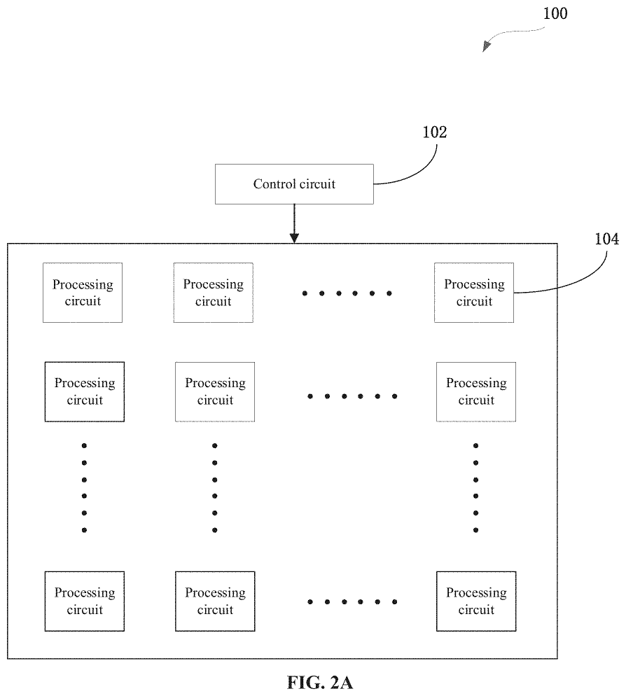

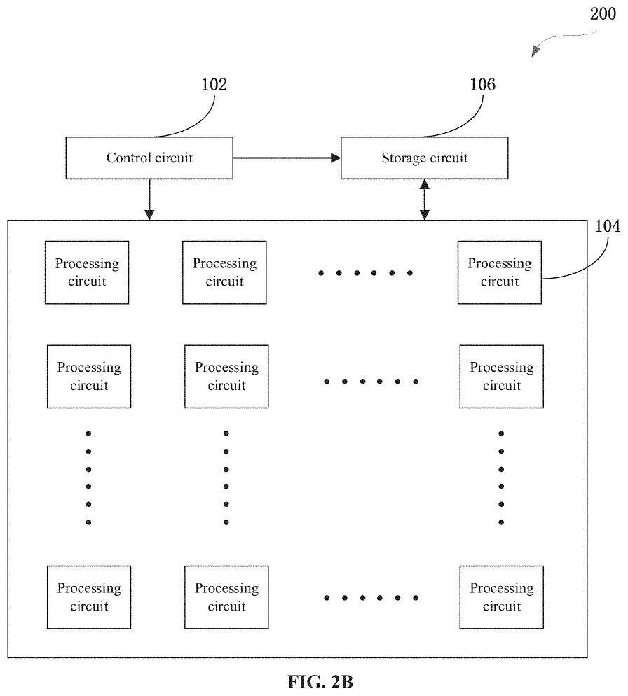

FIG. 2A is a block diagram of a computing apparatus 100 according to a second embodiment of the present disclosure. From the figure, it may be shown that, in addition to including the same processing circuit 104 as the computing apparatus 80, the computing apparatus 100 may further include a control circuit 102. In an embodiment, the control circuit 102 may be configured to acquire the aforementioned computing instruction and parse the computing instruction to obtain a plurality of operation instructions corresponding to a plurality of operations represented by the operation code, as shown in the formula (1). In another embodiment, the control circuit may configure a processing circuit array according to the plurality of operation instructions, so as to obtain a plurality of processing circuit sub-arrays, such as processing circuit sub-arrays including M1, M2, . . . Mn shown in FIG. 1.

In an application scenario, the control circuit may include a register used for storing configuration information, and the control circuit may extract corresponding configuration information according to the plurality of operation instructions and configure the processing circuit array according to the configuration information to obtain the plurality of processing circuit sub-arrays.

In an embodiment, the control circuit may include one or a plurality of registers, which may store configuration information about the processing circuit arrays, and the control circuit may be configured to read the configuration information from the register according to the configuration instruction and send the configuration information to the processing circuits, so that the processing circuits may be connected according to the configuration information.

In an application scenario, the configuration information may include preset position information of processing circuits constituting one or a plurality of processing circuit arrays, and the position information, for example, may include coordinate information of the processing circuits or label information of the processing circuits.

When the processing circuit arrays are configured to form the closed loop, the configuration information may further include loop configuration information about the processing circuit arrays forming the closed loop. Alternatively, in an embodiment, the aforementioned configuration information may be carried directly by the configuration instruction rather than read from the register. In this situation, the processing circuit may be configured directly according to the position information in the received configuration instruction, so as to form an array without a closed loop or an array with a closed loop with other processing circuits.

When the processing circuits are configured to be connected into a two-dimensional array according to the configuration instruction or the configuration information obtained from the register, a processing circuit located in the two-dimensional array is configured to be connected in a predetermined two-dimensional interval mode with one or more of the remaining processing circuits in the same row, column, or diagonal in at least one of row, column, or diagonal directions of the processing circuit. Here, the aforementioned predetermined two-dimensional interval mode may be associated with the number of processing circuits spaced in the connection.

Further, when the processing circuits are configured to be connected into a three-dimensional array according to the aforementioned configuration instruction or the aforementioned configuration information, the processing circuit array is connected in a loop-forming manner of a three-dimensional array composed of multiple layers, where each layer includes a two-dimensional array of the plurality of processing circuits arranged along row, column, and diagonal directions, and a processing circuit located in the three-dimensional array is configured to be connected in a predetermined three-dimensional interval mode with one or a plurality of the remaining processing circuits in the same row, column, diagonal or a different layer in at least one of row, column, diagonal, and layer directions of the processing circuit. Here, the predetermined three-dimensional interval mode may be associated with the number of intervals and the number of layers of intervals between to-be-connected processing circuits.

FIG. 2B is a block diagram of a computing apparatus 200 according to a second embodiment of the present disclosure. From the figure, it may be shown that, in addition to including the same control circuit 102 and a plurality of processing circuits 104 as the computing apparatus 100, the computing apparatus 200 of FIGS. 2A-2B may further include a storage circuit 106.

In an application scenario, the aforementioned storage circuit may be configured with interfaces used for data transfer in multiple directions, so as to be connected to the plurality of processing circuits 104, thus correspondingly storing to-be-computed data of the processing circuits, an intermediate result obtained during an operation process, and an operation result obtained after the operation process. In view of the aforementioned situation, in an application scenario, the storage circuit of the present disclosure may include a host storage unit and/or a host caching unit, where the host storage unit is configured to store data used to perform the operation in the processing circuit arrays and an operation result after the operation, and the host caching unit is configured to cache an intermediate operation result after the operation in the processing circuit arrays. Further, the storage circuit may further include an interface used for data transfer with an off-chip storage medium, thus implementing data moving between an on-chip system and an off-chip system.

FIG. 3 is a block diagram of a computing apparatus 300 according to a third embodiment of the present disclosure. From the figure, it may be shown that, in addition to including the same control circuit 102, a plurality of processing circuits 104, and storage circuit 106 as the computing apparatus 200, the computing apparatus 300 of FIG. 3 may further include a data operating circuit 108, which may include a pre-operating circuit 110 and a post-operating circuit 112. Based on such a hardware architecture, the pre-operating circuit 110 is configured to perform pre-processing on input data of at least one operation instruction, and the post-operating circuit 112 is configured to perform post-processing on output data of at least one operation instruction. In an embodiment, the pre-processing performed by the pre-operating circuit may include data placement and/or lookup table operations, and the post-processing performed by the post-operating circuit may include data type conversion and/or compression operations.

In an application scenario, in performing the lookup table operation, the pre-operating circuit is configured to look up one or a plurality of tables through an index value, so as to obtain one or a plurality of constant terms associated with an operand from the one or the plurality of tables. Additionally or alternatively, the pre-operating circuit is configured to determine the associated index value according to the operand and look up the one or the plurality of tables through the index value, so as to obtain the one or the plurality of constant terms associated with the operand from the one or the plurality of tables.

In an application scenario, according to a type of operation data and a logical address of each processing circuit, the pre-operating circuit may split the operation data accordingly and respectively send a plurality of pieces of sub-data obtained after splitting to each corresponding processing circuit in the array for the operation. In another application scenario, according to the parsed instruction, the pre-operating circuit may select a data concatenation mode from a variety of data concatenation modes to perform concatenation of two pieces of data that are input. In an application scenario, the post-operating circuit may be configured to perform a compression operation on data, and the compression operation includes using a mask to filtrate the data or comparing a given threshold with the data to filtrate the data, thereby implementing the compression of the data.

Based on the aforementioned hardware architecture of FIG. 3, the computing apparatus of the present disclosure may perform the computing instruction including the aforementioned pre-processing and the aforementioned post-processing. Based on this, the data conversion operation of the computing instruction expressed by the formula (1) may be performed by the aforementioned post-operating circuit. The following will describe two examples of the computing instruction according to the solution of the present disclosure.

Example 1: TMUADCO=MULT+ADD+RELU(N)+CONVERTFP2FIX (2).

The instruction expressed by the formula (2) is a computing instruction of inputting one 3-element operand and outputting one 1-element operand, and the instruction may be completed by one processing circuit matrix including a three-stage pipeline operation (including multiplication+addition+activation) of the present disclosure. Specifically, a three-element operation is A*B+C, where a micro-instruction of MULT completes a multiplication operation between an operand A and an operand B to obtain a multiplication product, which is a first-stage pipeline operation. Next, a micro-instruction of performing ADD completes an addition operation between the aforementioned multiplication product and C to obtain a summation result “N”, which is a second-stage pipeline operation. Then, an activation operation RELU is performed on the result, which is a third-stage pipeline operation. After the three-stage pipeline operation, finally, by using the post-operating circuit above to perform a micro-instruction CONVERTFP2FIX, a type of result data after the activation operation may be converted from a floating-point number into a fixed-point number, so as to serve as a final result or an intermediate result to be input into a fixed-point computing unit for a further computing operation.

Example 2: □TSEADMUAD=SEARCHADD+MULT+ADD (3).

The instruction expressed by the formula (3) is a computing instruction of inputting one 3-element operand and outputting one 1-element operand, and the instruction may include a micro-instruction that may be completed by one processing circuit matrix including a two-stage pipeline operation (including multiplication+addition) of the present disclosure. Specifically, the three-element operation is A*B+C, where a micro-instruction of SEARCHADD may be completed by the pre-operating circuit to obtain a lookup table result A. Next, the multiplication operation between the operand A and the operand B is completed by the first-stage pipeline operation to obtain the multiplication product. Then, the micro-instruction of performing ADD completes the addition operation between the aforementioned multiplication product and C to obtain the summation result “N”, which is the second-stage pipeline operation.

As described earlier, the computing instruction of the present disclosure may be designed and determined flexibly according to computing requirements. As such, the hardware architecture including the plurality of processing circuit sub-matrices of the present disclosure may be designed and connected according to the computing instruction and operations that are completed specifically by the computing instruction, thus improving execution efficiency of the instruction and reducing computing overheads.

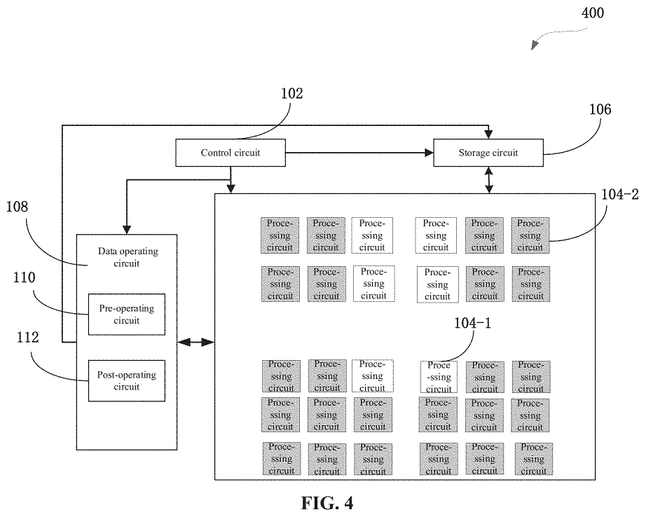

FIG. 4 is an exemplary structural diagram of a multi-type processing circuit array of a computing apparatus 400 according to an embodiment of the present disclosure. From the figure, it may be shown that a structure of the computing apparatus 400 shown in FIG. 4 is similar to that of the computing apparatus 300 shown in FIG. 3, and therefore, a description of the computing apparatus 300 in FIG. 3 is also applicable to the same details shown in FIG. 4, and the following will not describe again.

Form FIG. 4, it may be shown that the plurality of processing circuits may include, for example, a plurality of first type processing circuits 104-1 and a plurality of second type processing circuits 104-2 (which are distinguished by different background colors in the figure). The plurality of processing circuits may be arranged through a physical connection to form a two-dimensional array. For example, as shown in the figure, the two-dimensional array may have M rows and N columns (denoted by M*N) of first type processing circuits, where both M and N are positive integers greater than 0. The first type processing circuit may be used to perform an arithmetic operation and a logical operation, such as a linear operation including an addition, a subtraction, and a multiplication, a nonlinear operation, a comparison operation, and an and-or-invert operation, or any number of combinations of the above. Further, there are two columns of second type processing circuits on left and right sides of the periphery of M*N first type processing circuit array respectively, which are totally (M*2+M*2) second type processing circuits, and there are two rows of second type processing circuits on a lower side of the periphery, which are totally (N*2+8) second type processing circuits. In other words, the processing circuit array consists of (M*2+M*2+N*2+8) second type processing circuits. In an embodiment, the second type processing circuit may be used to perform a nonlinear operation, such as the comparison operation, a lookup table operation, or a shift operation, on the received data. In one or a plurality of embodiments, the first type processing circuit may be formed into a first processing circuit sub-array of the present disclosure, and the second type processing circuit may be formed into a second processing circuit sub-array of the present disclosure, so as to perform a multi-thread operation. In a scenario, when the multi-thread operation involves a plurality of operation instructions and the plurality of operation instructions constitute a multi-stage pipeline operation, the first processing circuit sub-array may perform several stages of pipeline operation in the multi-stage pipeline operation, and the second processing circuit sub-array may perform other several stages of pipeline operation. In another scenario, when the multi-thread operation involves the plurality of operation instructions and the plurality of operation instructions constitute two multi-stage pipeline operations, the first processing circuit sub-array may perform a first multi-stage pipeline operation, and the second processing circuit sub-array may perform a second multi-stage pipeline operation.

In some application scenarios, storage circuits that are applied by the first type processing circuit and the second type processing circuit may have different storage sizes and storage methods. For example, a predicate storage circuit in the first type processing circuit may store predicate information by using a plurality of numbered registers. Further, the first type processing circuit may access predicate information in a correspondingly-numbered register according to a register serial number specified in the parsed instruction received. For another example, the second type processing circuit may store predicate information by using a manner of a static random access memory (SRAM). Specifically, the second type processing circuit may determine a storage address of the predicate information in the SRAM according to an offset of a position of the predicate information specified in the parsed instruction received, and may perform a predetermined read or write operation on the predicate information in the storage address.

FIGS. 5A, 5B, 5C and 5D are schematic diagrams of multiple types of connections of a plurality of processing circuits according to embodiments of the present disclosure. As described earlier, the plurality of processing circuits of the present disclosure may be connected in the form of a hardwired connection or a logic connection according to a configuration instruction, thereby forming a connected topological structure of a one-dimensional or multi-dimensional array. If the plurality of processing circuits are connected in the form of the multi-dimensional array, the multi-dimensional array may be a two-dimensional array, and a processing circuit located in the two-dimensional array may be connected in a predetermined two-dimensional interval mode with one or a plurality of the remaining processing circuits in the same row, column or diagonal in at least one of row, column or diagonal directions of the processing circuit. The predetermined two-dimensional interval mode may be associated with the number of processing circuits spaced in the connection. FIGS. 5A-5C show topological structures of various forms of two-dimensional arrays between the plurality of processing circuits.

As shown in FIG. 5A, five processing circuits (where each is represented by a box) are connected to form a simple two-dimensional array. Specifically, one processing circuit may be used as a center of the two-dimensional array, and other four processing circuits are connected in four directions of horizontal and vertical sides of the processing circuit, thereby forming a two-dimensional array with three rows and three columns. Further, since the processing circuit at the center of the two-dimensional array is directly connected with adjacent processing circuits in previous and next columns in the same row and adjacent processing circuits in upper and lower rows in the same column respectively, the number of spaced processing circuits (referred to as “the number of intervals”) is 0.

As shown in FIG. 5B, four rows and four columns of processing circuits may be connected to form a two-dimensional Torus array, where each processing circuit is connected with adjacent processing circuits in previous and next rows and adjacent processing circuits in previous and next columns respectively; in other words, the number of intervals connected by the adjacent processing circuits is 0. Further, the first processing circuit in each row or each column of the two-dimensional Torus array is also connected to the last processing circuit in that row or that column, and the number of intervals between processing circuits connected end to end in each row or each column is 2.

As shown in FIG. 5C, four rows and four columns of processing circuits may be connected to form a two-dimensional array where the number of intervals between adjacent processing circuits is 0 and the number of intervals between non-adjacent processing circuits is 1. Specifically, adjacent processing circuits in the same row or column of the two-dimensional array are directly connected; in other words, the number of intervals is 0. Non-adjacent processing circuits in the same row or column are connected to processing circuits whose number of intervals is 1. It may be shown that, if the plurality of processing circuits are connected to form the two-dimensional array, there may be a different number of intervals between the processing circuits in the same row or column shown in FIG. 5B and FIG. 5C. Similarly, in some scenarios, processing circuits in the diagonal direction may also be connected in different numbers of intervals.

As shown in FIG. 5D, by using four two-dimensional Torus arrays as shown in FIG. 5B, four layers of two-dimensional Torus arrays may be arranged at a predetermined interval and connected to form a three-dimensional Torus array. Based on the two-dimensional Torus array, the three-dimensional Torus array are connected between layers by using an interval mode similar to that between rows and that between columns. For example, first, processing circuits in the same row and column of an adjacent layer are directly connected; in other words, the number of intervals is 0. Then, processing circuits in the same row and column of the first layer and the last layer are connected; in other words, the number of intervals is 2. Finally, a three-dimensional Torus array with four layers, four rows and four columns is formed.

Through these examples above, those skilled in the art may understand that connections of other multi-dimensional arrays of the processing circuits may be formed by adding a new dimension and increasing the number of processing circuits on the basis of the two-dimensional array. In some application scenarios, a solution of the present disclosure may use a configuration instruction to configure a logical connection to the processing circuits. In other words, although there may be a hardwire connection between the processing circuits, the solution of the present disclosure may also use the configuration instruction to selectively connect some processing circuits, or selectively bypass some processing circuits, so as to form one or a plurality of logical connections. In some embodiments, the aforementioned logical connection may be adjusted according to actual operational requirements (such as a data type conversion). Further, for different computing scenarios, the solution of the present disclosure may configure the connection of the processing circuits as, for example, a matrix or one or a plurality of closed computing loops.

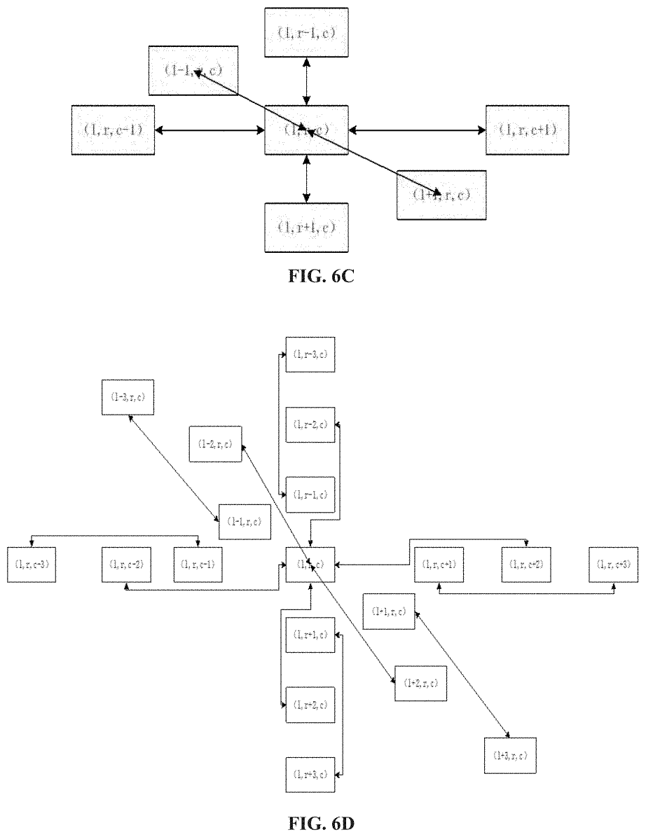

FIGS. 6A, 6B, 6C and 6D are schematic diagrams of other multiple types of connections of a plurality of processing circuits according to embodiments of the present disclosure. From figures, it may be shown that FIGS. 6A-6D show another exemplary connection of a multi-dimensional array formed by the plurality of processing circuits shown in FIGS. 5A-5D. Based on this, technical details described in combination with FIGS. 5A-5D are also applicable to FIGS. 6A-6D.

As shown in FIG. 6A, processing circuits of the two-dimensional array consist of a central processing circuit located in the center of the two-dimensional array and three processing circuits connected to the central processing circuit in each of four directions in the same row and the same column of the central processing circuit. Therefore, the numbers of intervals between the central processing circuit and the rest of the processing circuits are 0, 1, and 2, respectively. As shown in FIG. 6B, processing circuits of the two-dimensional array consist of a central processing circuit located in the center of the two-dimensional array, three processing circuits in each of two opposite directions in the same row as the central processing circuit, and one processing circuit in each of two opposite directions in the same column as the central processing circuit. Therefore, the numbers of intervals between the central processing circuit and the processing circuits in the same row are 0 and 2 respectively, and the numbers of intervals between the central processing circuit and the processing circuits in the same column are 0.

As shown earlier in combination with FIG. 5D, the multi-dimensional array formed by the plurality of processing circuits may be a three-dimensional array composed of a plurality of layers. Each layer of the three-dimensional array may include a two-dimensional array of the plurality of processing circuits arranged along row and column directions. Further, a processing circuit located in the three-dimensional array may be connected in a predetermined three-dimensional interval mode with one or a plurality of the remaining processing circuits in the same row, column, diagonal, or a different layer in at least one of row, column, diagonal, and layer directions of the processing circuit. Further, the predetermined three-dimensional interval mode and the number of processing circuits spaced in the connection may be associated with the layer number of intervals. The following will further describe the connection of the three-dimensional array in combination with FIG. 6C and FIG. 6D.

FIG. 6C shows a three-dimensional array with a plurality of layers, a plurality of rows, and a plurality of columns formed by the plurality of processing circuits. Taking a processing circuit located in the first layer, the r-th row, and the c-th column (which may be represented as (l, r, c)) as an example, the processing circuit is located in a central position of the array and is connected to processing circuits at a previous column (l, r, c−1) and a next column (l, r, c+1) in the same layer and the same row, processing circuits at a previous row (l, r−1, c) and a next row (l, r+1, c) in the same layer and the same column, and processing circuits at a previous layer (l−1, r, c) and a next layer (1+1, r, c) in the same row, the same column, and different layers, respectively. Further, the numbers of intervals between the processing circuit at (l, r, c) and other processing circuits connected in row, column, and layer directions are 0.

FIG. 6D shows a three-dimensional array when the numbers of intervals between the plurality of processing circuits connected in row, column, and layer directions are 1. Taking a processing circuit located in the central position of the array (l, r, c) as an example, the processing circuit is connected to processing circuits at (l, r, c−2) and (l, r, c+2) spaced one column front and back with the processing circuit in the same layer, the same row, and different columns, and processing circuits at (l, r−2, c) and (l, r+2, c) spaced one row front and back in the same layer, the same column, and different rows, respectively. Further, the processing circuit is connected to processing circuits at (l−2, r, c) and (1+2, r, c) spaced one layer front and back with the processing circuit in the same row, the same column, and different layers. Similarly, other processing circuits at (l, r, c−3) and (l, r, c−1) spaced one column with the processing circuit in the same layer and the same row are connected to each other, and processing circuits at (l, r, c+1) and (l, r, c+3) are connected to each other. Then, processing circuits at (l, r−3, c) and (l, r−1, c) spaced one row with the processing circuit in the same layer and the same column are connected to each other, and processing circuits at (l, r+1, c) and (l, r+3, c) are connected to each other. Similarly, processing circuits at (l−3, r, c) and (l−1, r, c) spaced one layer with the processing circuit in the same row and the same column are connected to each other, and processing circuits at (l+1, r, c) and (l+3, r, c) are connected to each other.

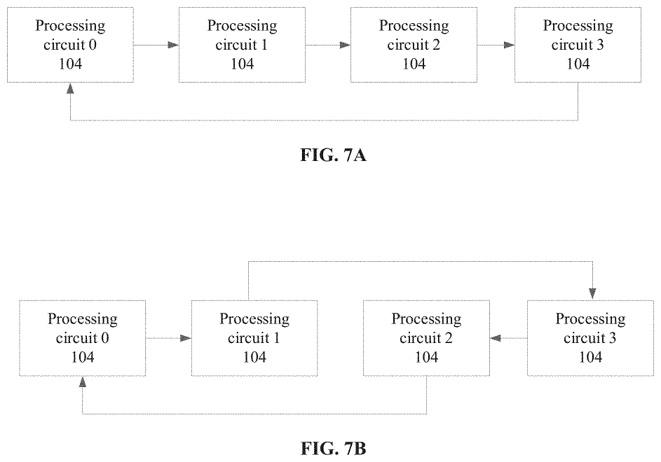

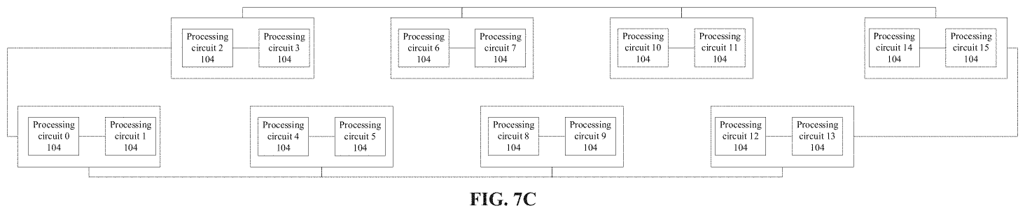

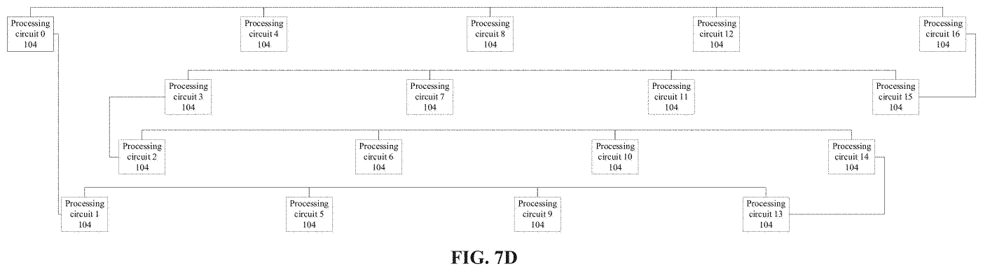

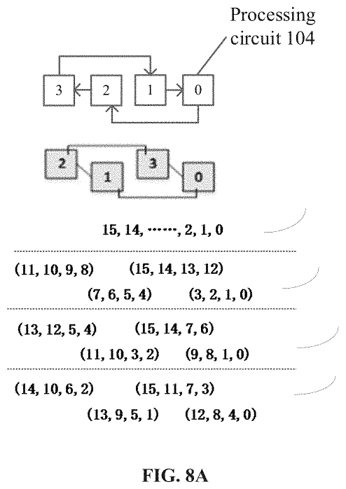

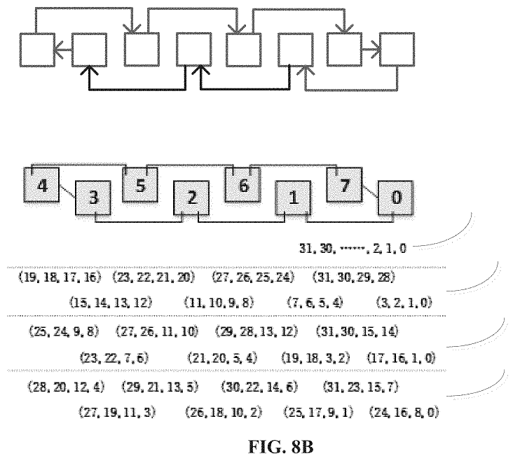

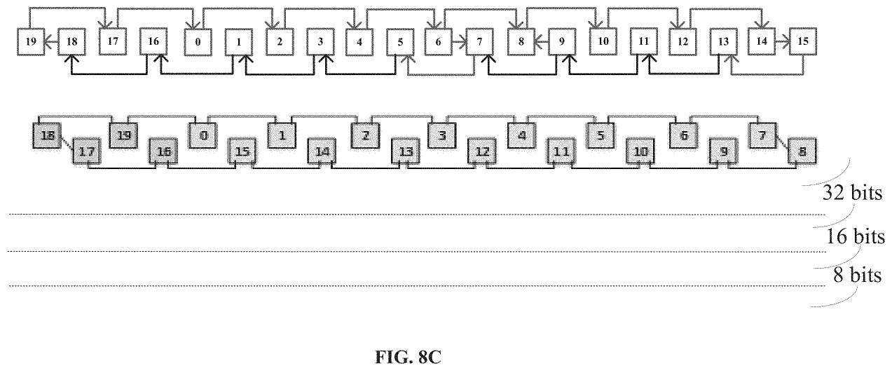

The above exemplarily describes the connection of the multi-dimensional array formed by the plurality of processing circuits. Different loop structures formed by the plurality of processing circuits will be further exemplified in combination with FIGS. 7A-8C below.

FIGS. 7A, 7B, 7C, and 7D show schematic diagrams of multiple types of loop structures of processing circuits respectively according to embodiments of the present disclosure. According to different application scenarios, the plurality of processing circuits may not only be connected through a physical connection, but also be configured to be connected through a logical connection according to the parsed instruction received. The plurality of processing circuits may be configured to use the logical connection to be connected to form a closed loop.

As shown in FIG. 7A, four adjacent processing circuits are sequentially numbered “0, 1, 2 and 3”. Then, the four processing circuits are sequentially connected from a processing circuit 0 in a clockwise direction, and a processing circuit 3 is connected to the processing circuit 0, so that the four processing circuits are connected in series to form the closed loop (“loop” for short). In this loop, the number of intervals of the processing circuits is 0 or 2. For example, the number of intervals between the processing circuit 0 and a processing circuit 1 is 0, and the number of intervals between the processing circuit 3 and the processing circuit 0 is 2. Further, physical addresses (also called physical coordinates in the present disclosure) of the four processing circuits in the loop may be represented as 0-1-2-3, and logical addresses (also called logical coordinates in the present disclosure) may similarly be represented as 0-1-2-3. It is required to be noted that a connection sequence shown in FIG. 7A is only exemplary rather than restrictive. According to actual computing requirements, those skilled in the art may also connect the four processing circuits in series in a counterclockwise direction to form the closed loop.

In some actual scenarios, if a data bit width supported by a processing circuit may not satisfy a bit width requirement of operation data, the plurality of processing circuits may be combined into a processing circuit group to represent a piece of data. For example, it is assumed that a processing circuit may process 8-bit data. If 32-bit data is required to be processed, the four processing circuits may be combined into the processing circuit group to connect four pieces of 8-bit data to form a piece of 32-bit data. Further, the processing circuit group formed by the aforementioned four 8-bit processing circuits may be used as a processing circuit 104 shown in FIG. 7B, so that a higher bit width operation may be supported.

From FIG. 7B, it may be shown that the layout of the processing circuits shown is similar to that shown in FIG. 7A, but the number of intervals between the processing circuits in FIG. 7B is different from that in FIG. 7A. FIG. 7B shows that four processing circuits numbered in order of 0, 1, 2 and 3 are connected clockwise from a processing circuit 0 to a processing circuit 1, a processing circuit 3 and a processing circuit 2, and the processing circuit 2 is connected to the processing circuit 0, thus forming a closed loop in series. From this loop, it may be shown that the number of intervals of the processing circuits shown in FIG. 7B is 0 or 1. For example, the number of intervals between the processing circuit 0 and the processing circuit 1 is 0, and the number of intervals between the processing circuit 1 and the processing circuit 3 is 1. Further, physical addresses of the four processing circuits in the closed loop may be 0-1-2-3, and according to the loop-forming manner shown, logical addresses may be represented as 0-1-3-2. Therefore, if high bit width data is required to be split for distribution to different processing circuits, data order may be rearranged and allocated according to logical addresses of the processing circuits.

The aforementioned operations of splitting and rearranging may be performed by the pre-operating circuit described in combination with FIG. 3. Especially, the pre-operating circuit may rearrange input data according to the physical addresses of the plurality of processing circuits and the logical addresses of the plurality of processing circuits to meet the requirements of data operation. Assuming that four sequentially-arranged processing circuits 0 to 3 are connected as shown in FIG. 7A, since both the physical addresses of the connection and the logical addresses of the connection are 0-1-2-3, the pre-operating circuit may send the input data (such as pixel data) such as aa0, aa1, aa2, and aa3 in turn to corresponding processing circuits. However, if the aforementioned four processing circuits are connected as shown in FIG. 7B, the physical addresses remain 0-1-2-3 unchanged, while the logical addresses become 0-1-3-2, and at this time, the pre-operating circuit is required to rearrange the input data aa0, aa1, aa2 and aa3 into aa0-aa1-aa3-aa2 to be sent to the corresponding processing circuits. Based on the above rearrangement of the input data, the solution of the present disclosure may ensure the correct order of data operation. Similarly, if the order of four operation output results obtained above (such as the pixel data) is bb0-bb1-bb3-bb2, the order of the operation output results may be restored and adjusted to bb0-bb1-bb2-bb3 by using the post-operating circuit described in combination with FIGS. 2A-2B, so as to ensure alignment consistency between input data and output result data.

FIG. 7C and FIG. 7D show that more processing circuits are arranged and connected in a different method respectively to form a closed loop. As shown in FIG. 7C, for 16 processing circuits 104 numbered in order of 0, 1, . . . , 15, starting with a processing circuit 0, each two processing circuits are connected and combined sequentially to form one processing circuit group (which is a processing circuit sub-array in the present disclosure). For example, as shown in the figure, the processing circuit 0 and a processing circuit 1 are connected to form one processing circuit group . . . . In a similar fashion, a processing circuit 14 and a processing circuit 15 are connected to form one processing circuit group. Finally, eight processing circuit groups are formed. Further, the eight processing circuit groups may be connected in a manner similar to that of the processing circuits described above, including connecting according to, for example, a predetermined logical address, so as to form a closed loop of processing circuit groups.

As shown in FIG. 7D, the plurality of processing circuits 104 are connected in an irregular or inconsistent manner, so as to form a processing circuit matrix with a closed loop. Specifically, FIG. 7D shows that the processing circuits may be connected in the number of intervals of 0 or 3 to form the closed loop. For example, a processing circuit 0 may be connected to a processing circuit 1 (where the number of intervals is 0) and a processing circuit 4 (where the number of interval is 3), respectively.

From the above description in combination with FIGS. 7A, 7B, 7C and 7D, it may be shown that the processing circuits of the present disclosure may be spaced in a different number of the processing circuits, so as to form the closed loop. If the total number of the processing circuits is changed, any number of intermediate intervals may be used for dynamic configuration, thus connecting the processing circuits into the closed loop. The plurality of processing circuits may also be combined into a processing circuit group and connected into a closed loop of processing circuit groups. Additionally, the connection of the plurality of processing circuits may be a hardware-based connection or a software-configured connection.

FIGS. 8A, 8B, and 8C show schematic diagrams of other multiple types of loop structures of processing circuits according to embodiments of the present disclosure. The plurality of processing circuits shown in combination with FIGS. 6A-6D may form a closed loop, and each processing circuit in the closed loop may be configured to have a respective logical address. Further, the pre-operating circuit described in combination with FIGS. 2A-2B may be configured to, according to a type of operation data (such as 32-bit data, 16-bit data, or 8-bit data) and the logical addresses, split the operation data accordingly and respectively send a plurality of pieces of sub-data obtained after splitting to each corresponding processing circuit in the loop for a subsequent operation.

The figure above of FIG. 8A illustrates that four processing circuits are connected to form a closed loop, and physical addresses of the four processing circuits in right-to-left order may be represented as 0-1-2-3. The figure below of FIG. 8A illustrates that logical addresses of the four processing circuits in the loop in right-to-left order may be represented as 0-3-1-2. For example, a processing circuit with a logical address “3” shown in the figure below of FIG. 8A has a physical address “1” shown in the figure above of FIG. 8A.

In some application scenarios, it is assumed that the granularity of operation data is low 128 bits of input data, such as an original sequence “15, 14, . . . , 2, 1, 0” (where each number corresponds to 8-bit data), and logical addresses of 16 pieces of 8-bit data are numbered from 0 to 15 in ascending order. Further, according to the logical addresses shown in the figure below of FIG. 8A, the pre-operating circuit may encode or arrange data with different logical addresses according to different data types.

If a data bit width operated by the processing circuit is 32 bits, four numbers whose logical addresses are (3, 2, 1, 0), (7, 6, 5, 4), (11, 10, 9, 8), and (15, 14, 13, 12) respectively may represent 0th to 3rd pieces of 32-bit data respectively. The pre-operating circuit may send the 0th piece of 32-bit data to a processing circuit whose logical address is “0” (whose corresponding physical address is “0”), send the 1st piece of 32-bit data to a processing circuit whose logical address is “1” (whose corresponding physical address is “2”), send the 2nd piece of 32-bit data to a processing circuit whose logical address is “2” (whose corresponding physical address is “3”), and send the 3rd piece of 32-bit data to a processing circuit whose logical address is “3” (whose corresponding physical address is “1”). The data is rearranged to meet the subsequent operation requirements of the processing circuit. Therefore, a mapping between logical addresses of final data and physical addresses of the final data is (15, 14, 13, 12, 11, 10, 9, 8, 7, 6, 5, 4, 3, 2, 1, 0)->(11, 10, 9, 8, 7, 6, 5, 4, 15, 14, 13, 12, 3, 2, 1, 0).

If the data bit width operated by the processing circuit is 16 bits, eight numbers whose logical addresses are (1, 0), (3, 2), (5, 4), (7, 6), (9, 8), (11, 10), (13, 12) and (15, 14) respectively may represent 0th to 7th pieces of 16-bit data respectively. The pre-operating circuit may send the 0th piece of 16-bit data and the 4th piece of 16-bit data to the processing circuit whose logical address is “0” (whose corresponding physical address is “0”), send the 1st piece of 16-bit data and the 5th piece of 16-bit data to the processing circuit whose logical address is “1” (whose corresponding physical address is “2”), send the 2nd piece of 16-bit data and the 6th piece of 16-bit data to the processing circuit whose logical address is “2” (whose corresponding physical address is “3”), and send the 3rd piece of 16-bit data and the 7th piece of 16-bit data to the processing circuit whose logical address is “3” (whose corresponding physical address is “1”). Therefore, the mapping between the logical addresses of the final data and the physical addresses of the final data is:
(15, 14, 13, 12, 11, 10, 9, 8, 7, 6, 5, 4, 3, 2, 1, 0)->(13, 12, 5, 4, 11, 10, 3, 2, 15, 14, 7, 6, 9, 8, 1, 0).

If the data bit width operated by the processing circuit is 8 bits, 16 numbers whose logical addresses numbered from 0 to 15 may represent 0th to 15th pieces of 8-bit data respectively. According to the connection shown in FIG. 8A, the pre-operating circuit may send the 0th piece of 8-bit data, the 4th piece of 8-bit data, the 8th piece of 8-bit data, and the 12th piece of 8-bit data to the processing circuit whose logical address is “0” (whose corresponding physical address is “0”), send the 1st piece of 8-bit data, the 5th piece of 8-bit data, the 9th piece of 8-bit data, and the 13th piece of 8-bit data to the processing circuit whose logical address is “1” (whose corresponding physical address is “2”), send the 2nd piece of 8-bit data, the 6th piece of 8-bit data, the 10th piece of 8-bit data, and the 14th piece of 8-bit data to the processing circuit whose logical address is “2” (whose corresponding physical address is “3”), and send the 3rd piece of 16-bit data, the 7th piece of 16-bit data, the 11th piece of 8-bit data, and the 15th piece of 8-bit data to the processing circuit whose logical address is “3” (whose corresponding physical address is “1”). Therefore, the mapping between the logical addresses of the final data and the physical addresses of the final data is: (15, 14, 13, 12, 11, 10, 9, 8, 7, 6, 5, 4, 3, 2, 1, 0)->(14, 19, 6, 2, 13, 9, 5, 1, 15, 11, 7, 3, 12, 8, 4, 0).

The figure above of FIG. 8B illustrates that eight processing circuits sequentially numbered 0-7 are connected to form a closed loop, and physical addresses of the eight processing circuits are 0-1-2-3-4-5-6-7. The figure below of FIG. 8B illustrates that logical addresses of the aforementioned eight processing circuits are 0-7-1-6-2-5-3-4. For example, a processing circuit with a physical address “6” as shown in the figure above of FIG. 8B corresponds to a logical address “3” as shown in the figure below of FIG. 8B.

For different data types, an operation of rearranging data and then sending the data to corresponding processing circuits by the aforesaid pre-operating circuit shown in FIG. 8B is similar to that in FIG. 8A. Therefore, a technical solution described in combination with FIG. 8A is also applicable to FIG. 8B, and the aforesaid data rearrangement operation process will not be described here. Further, the connection of the processing circuits shown in FIG. 8B is similar to that in FIG. 8A, but eight processing circuits shown in FIG. 8B is twice of the number of processing circuits shown in FIG. 8A. As such, in an application scenario where an operation is performed according to different data types, the granularity of operation data described in combination with FIG. 8B may be twice of that described in combination with FIG. 8A. Therefore, compared with the previous example, where the granularity of input data is low 128 bits, the granularity of operation data in this example may be low 256 bits of input data, such as an original data sequence “31, 30, . . . , 2, 1, 0” shown in the figure, and each number corresponds to a length of 8 bits.

For the aforementioned original data sequence, if a data bit width operated by the processing circuit is 32 bits, 16 bits, and 8 bits respectively, results of data arrangement of looped processing circuits are also shown respectively. For example, if a data bit width operated is 32 bits, a piece of 32-bit data in a processing circuit whose logical address is “1” is (7, 6, 5, 4), and a corresponding physical address of the processing circuit is “2”. If the data bit width operated is 16 bits, two pieces of 16-bit data in a processing circuit whose logical address is “3” are (23, 22, 7, 6), and the corresponding physical address of the processing circuit is “6”. If the data bit width operated is 8 bits, four pieces of 8-bit data in a processing circuit whose logical address is “6” are (30, 22, 14, 6), and the corresponding physical address of the processing circuit is “3”.

The above has described data operations of different data types in combination with a case in which multiple single-type processing circuits (such as the first type processing circuit shown in FIG. 3) are connected to form a closed loop shown in FIG. 8A and FIG. 8B. The following will further describe data operations of different data types in combination with a case in which multiple different-type processing circuits (such as the first type processing circuit and the second type processing circuit shown in FIG. 4) are connected to form a closed loop shown in FIG. 8C.

The figure above of FIG. 8C illustrates that 20 multi-type processing circuits sequentially numbered 0, 1, . . . , 19 are connected to form a closed loop (where numbers shown are physical addresses of the processing circuits). 16 processing circuits numbered from 0 to 15 are first type processing circuits (which may be formed into a processing circuit sub-array of the present disclosure), and four processing circuits numbered from 16 to 19 are second type processing circuits (which may be formed into the processing circuit sub-array of the present disclosure). Similarly, a physical address of each of the 20 processing circuits has a mapping relationship with a logical address of a corresponding processing circuit shown in the figure below of FIG. 8C.

Further, when different data types are operated, such as an original sequence of 80 pieces of 8-bit data shown in the figure, FIG. 8C also shows results of operations on the original data described above according to different data types supported by the processing circuits. For example, if a data bit width operated is 32 bits, a piece of 32-bit data in a processing circuit whose logical address is “1” is (7, 6, 5, 4), and a corresponding physical address of the processing circuit is “2”. If the data bit width operated is 16 bits, two pieces of 16-bit data in a processing circuit whose logical address is “11” are (63, 62, 23, 22), and the corresponding physical address of the processing circuit is “9”. If the data bit width operated is 8 bits, four pieces of 8-bit data in a processing circuit whose logical address is “17” are (77, 57, 37, 17), and the corresponding physical address of the processing circuit is “18”.

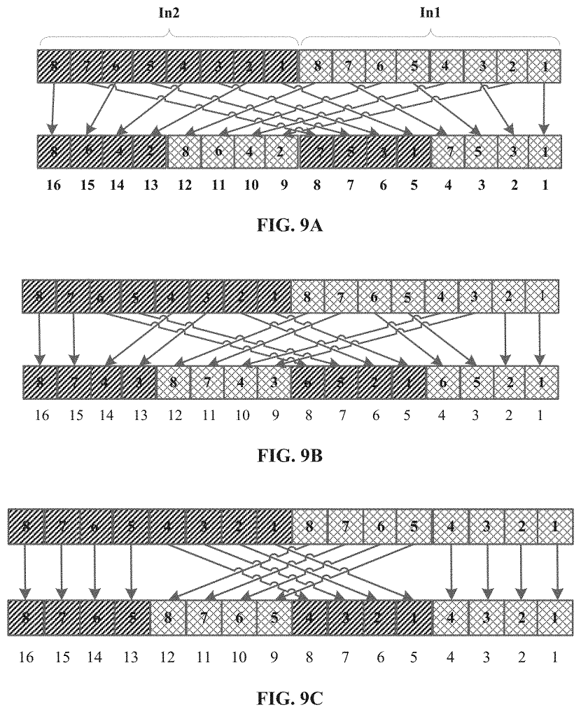

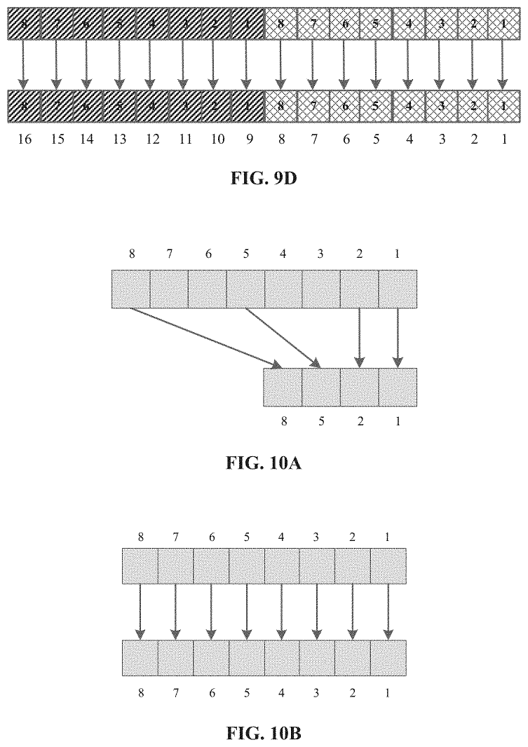

FIGS. 9A, 9B, 9C and 9D show schematic diagrams of a data concatenation operation performed by a pre-operating circuit according to embodiments of the present disclosure. As described earlier, the pre-operating circuit of the present disclosure described in combination with FIGS. 2A-2B may be further configured to select a data concatenation mode from a variety of data concatenation modes according to the parsed instruction to perform concatenation of two pieces of data that are input. Regarding the variety of data concatenation modes, in an embodiment, a solution of the present disclosure divides and numbers two pieces of to-be-concatenated data according to a minimum data unit, and then extracts different minimum data units of the data based on a specified rule to form different data concatenation modes. For example, the different data concatenation modes may be formed by, for example, alternatively extracting and placing based on the parity of a number or whether the number is an integer multiple of a specified number. According to different computing scenarios (such as different data bit widths), here, the minimum data unit may be simply 1-digit data or 1-bit data, or 2 digits or bits, 4 digits or bits, 8 digits or bits, 16 digits or bits, or 32 digits or bits. Further, when extracting different numbered parts of the two pieces of data, the solution of the present disclosure may extract the data alternately according to the minimum data unit or according to multiples of the minimum data unit. For example, part data of two or three minimum data units may be extracted alternatively at a time from the two pieces of data as one group to perform the concatenation by group.

Based on the description of data concatenation modes above, the following will illustrate the data concatenation modes of the present disclosure with specific examples in combination with FIGS. 9A-9C. In the figure, input data is In1 and In2, and if each square in the figure represents a minimum data unit, both two pieces of input data have a bit width length of 8 minimum data units. As described earlier, for data with different bit width lengths, the minimum data unit may be used to represent different digit numbers (or bit numbers). For example, for data with a bit width of 8 bits, the minimum data unit represents 1-bit data, while for data with a bit width of 16 bits, the minimum data unit represents 2-bit data. For another example, for data with a bit width of 32 bits, the minimum data unit represents 4-bit data.

As shown in FIG. 9A, two pieces of to-be-concatenated input data In1 and In2 are respectively composed of eight minimum data units numbered 1, 2, . . . , 8 sequentially from right to left. Date concatenation may be performed based on numbering from small to large, In1 first and In2 later, and a parity interleaving principle of an odd number first and an even number later. Specifically, if a data bit width operated is 8 bits, In1 and In2 each represents a piece of 8-bit data, and each minimum data unit represents 1-bit data (in other words, one square represents 1-bit data). According to the bit width of the data and the aforementioned concatenation principle, minimum data units numbered 1, 3, 5 and 7 of In1 may be extracted and placed in low bits sequentially. Then, four odd-numbered minimum data units of In2 may be placed sequentially. Similarly, minimum data units numbered 2, 4, 6, and 8 of In1 and four even-numbered minimum data units of In2 may be placed sequentially. Finally, 16 minimum data units may be concatenated together to form one piece of 16-bit new data or two pieces of 8-bit new data, as shown in squares in a second row of FIG. 9A.

As shown in FIG. 9B, if the data bit width is 16 bits, In1 and In2 each represents a piece of 16-bit data, and at this time, each minimum data unit represents 2-bit data (in other words, one square represents one piece of 2-bit data). According to the bit width of the data and the aforementioned interleaving concatenation principle, minimum data units numbered 1, 2, 5 and 6 of In1 may be extracted and placed in the low bits sequentially. Then, minimum data units numbered 1, 2, 5, and 6 of In2 may be placed sequentially. Similarly, minimum data units numbered 3, 4, 7, and 8 of In1 and minimum data units numbered 3, 4, 7, and 8 of In2 may be placed sequentially, so that the minimum data units are concatenated to form one final piece of 32-bit new data or two final pieces of 16-bit new data composed of 16 minimum data units, as shown in squares in a second row of FIG. 9B.

As shown in FIG. 9C, if the data bit width is 32 bits, In1 and In2 each represents a piece of 32-bit data, and each minimum data unit represents 4-bit data (in other words, one square represents one piece of 4-bit data). According to the bit width of the data and the aforementioned interleaving concatenation principle, minimum data units numbered 1, 2, 3 and 4 of In1 and minimum data units numbered 1, 2, 3 and 4 of In2 may be extracted and placed in the low bits sequentially. Then, minimum data units numbered 5, 6, 7, and 8 of In1 and minimum data units numbered 5, 6, 7, and 8 of In2 may be extracted and placed sequentially, so that the minimum data units are concatenated to form one final piece of 64-bit new data or two final pieces of 32-bit new data composed of 16 minimum data units.

The above has described exemplary data concatenation methods of the present disclosure in combination with FIGS. 9A-9C. However, it may be understood that, in some computing scenarios, the data concatenation does not involve the aforementioned alternative placement, but the data concatenation is simple placement of two pieces of data with respective original data positions unchanged, as shown in FIG. 9D. From FIG. 9D, it may be shown that two pieces of data In1 and In2 do not perform the alternative placement shown in FIGS. 9A-9C, but a last minimum data unit of In1 and a first minimum data unit of In2 are concatenated only, thus obtaining a new data type with an increased bit width (such as a double bit width). In some scenarios, the solution of the present disclosure may perform the concatenation by group based on data properties. For example, neuron data or weight data featuring a same feature map may be formed into one group and then arranged, so as to form a continuous part of the concatenated data.

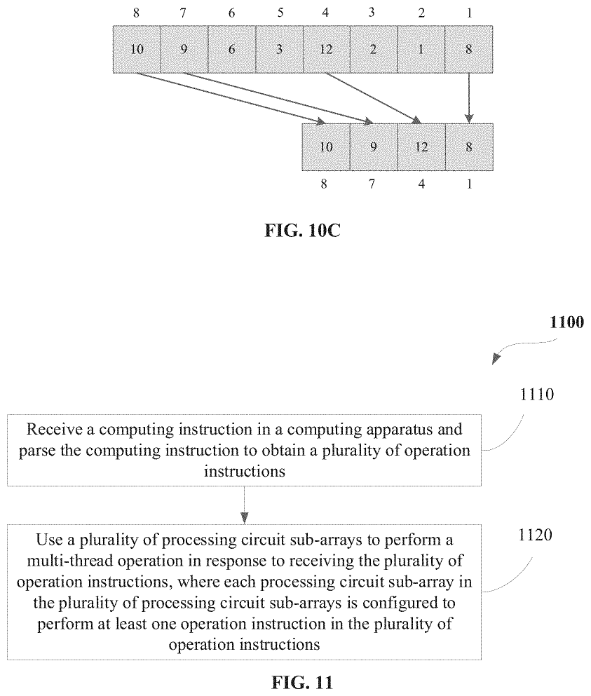

FIGS. 10A, 10B, and 10C show schematic diagrams of a data compression operation performed by a post-processing circuit according to embodiments of the present disclosure. The compression operation may include using a mask to filtrate data or comparing a given threshold with the data. Regarding the data compression operation, division and numbering may be performed according to the minimum data unit described above. Similar to the description in combination with FIGS. 9A-9D, the minimum data unit may be, for example, 1-digit data or 1-bit data, or 2 digits or bits, 4 digits or bits, 8 digits or bits, 16 digits or bits, or 32 digits or bits. The following will exemplarily describe different data compression modes in combination with FIGS. 10A-10C.

As shown in FIG. 10A, original data is formed by arranging eight squares (which are eight minimum data units) numbered 1, 2, . . . , 8 sequentially from right to left in turn, and it is assumed that each minimum data unit may represent 1-bit data. When performing the data compression operation according to the mask, the post-operating circuit may use the mask to filtrate the original data to perform the data compression operation. In an embodiment, a bit width of the mask corresponds to the number of minimum data units of the original data. For example, if the aforementioned original data has eight minimum data units, the bit width of the mask is 8 bits, and a minimum data unit numbered 1 corresponds to a lowest bit of the mask, and a minimum data unit numbered 2 corresponds to a second lowest bit of the mask. In a similar fashion, a minimum data unit numbered 8 corresponds to a highest bit of the mask. In an application scenario, if an 8-bit mask is “10010011”, a compression principle may be set to extract a minimum data unit in the original data corresponding to a data bit with a mask “1”. For example, a minimum data unit corresponding to a mask value “1” may be numbered 1, 2, 5, and 8. As such, minimum data units numbered 1, 2, 5, and 8 may be extracted and arranged in turn in ascending order, so as to form new data after the compression, as shown in a second row of FIG. 10A.

FIG. 10B shows original data similar to that of FIG. 10A, and from a second row of FIG. 10B, it may be shown that a data sequence after the post-operating circuit maintains an original data arrangement order and original content. As such, it may be understood that data compression of the present disclosure may further include a prohibition mode or a non-compression mode, so that the compression operation may not be performed when the data passes through the post-operating circuit.

As shown in FIG. 10C, original data is formed by arranging eight squares in turn. A number above each square represents a serial number of the square. The eight squares are numbered 1, 2, . . . , 8 sequentially from right to left. Moreover, it is assumed that each minimum data unit may be 8-bit data. Further, a number in each square represents a decimal value of the minimum data unit. Taking a minimum data unit numbered 1 as an example, the decimal value of the minimum data unit is “8”, and corresponding 8-bit data is “00001111”. When the data compression operation is performed according to the threshold, it is assumed that the threshold is a piece of decimal data “8”, and the compression principle may be set to extract all minimum data units greater than or equal to the threshold “8” in the original data. As such, minimum data units numbered 1, 4, 7, and 8 may be extracted. Then, all minimum data units obtained by extracting may be arranged in ascending order, so as to obtain a final data result, as shown in a second row of FIG. 10C.

FIG. 11 is a simplified flowchart of a method 1100 of using a computing apparatus to perform a computing operation according to an embodiment of the present disclosure. According to the description above, it may be understood that here, the computing apparatus may be the computing apparatus described in combination with FIGS. 1-4, which may have processing circuit connections shown in FIGS. 5A-10C and support various additional operations.

As shown in FIG. 11, in a step 1110, the method 1100 receives a computing instruction in the computing apparatus and parses the computing instruction to obtain a plurality of operation instructions. Next, in a step 1120, the method 1100 uses a plurality of processing circuit sub-arrays to perform a multi-thread operation in response to receiving the plurality of operation instructions, where each processing circuit sub-array in the plurality of processing circuit sub-arrays is configured to perform at least one operation instruction in the plurality of operation instructions.

For the sake of brevity, the above describes the computing method of the present disclosure only in combination with FIG. 11. According to the disclosed contents of the present disclosure, those skilled in the art may also think that this method may include more steps, and the execution of these steps may realize various operations described above in combination with FIGS. 1-10C, which will not be described here.

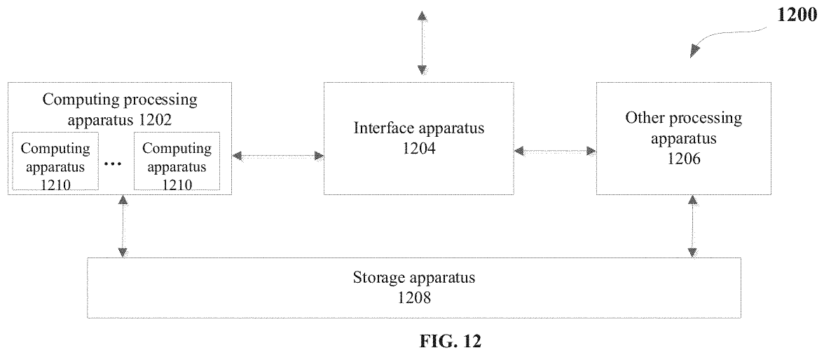

FIG. 12 is a structural diagram of a combined processing apparatus 1200 according to an embodiment of the present disclosure. As shown in FIG. 12, the combined processing apparatus 1200 may include a computing processing apparatus 1202, an interface apparatus 1204, other processing apparatus 1206, and a storage apparatus 1208. According to different application scenarios, the computing processing apparatus includes one or a plurality of computing apparatuses 1210, and the computing apparatus is configured to perform an operation described above in combination with FIGS. 1-11.

In different embodiments, the computing processing apparatus of the present disclosure may be configured to perform an operation specified by a user. In an exemplary application, the computing processing apparatus may be implemented as a single-core artificial intelligence processor or a multi-core artificial intelligence processor. Similarly, one or a plurality of computing apparatuses included in the computing processing apparatus may be implemented as an artificial intelligence processor core or a partial hardware structure of the artificial intelligence processor core. If the plurality of computing apparatuses are implemented as artificial intelligence processor cores or partial hardware structures of the artificial intelligence processor cores, the computing processing apparatus of the present disclosure may be regarded as having a single-core structure or an isomorphic multi-core structure.

In an exemplary operation, the computing processing apparatus of the present disclosure interacts with other processing apparatus through the interface apparatus, so as to jointly complete the operation specified by the user. According to different implementations, other processing apparatus of the present disclosure may include one or more kinds of general and/or dedicated processors, including a central processing unit (CPU), a graphics processing unit (GPU), an artificial intelligence processor, and the like. These processors may include but are not limited to a digital signal processor (DSP), an application specific integrated circuit (ASIC), a field-programmable gate array (FPGA), or other programmable logic devices, discrete gate or transistor logic devices, discrete hardware components, and the like. The number of the processors may be determined according to actual requirements. As described above, the computing processing apparatus of the present disclosure may be regarded as having the single-core structure or the isomorphic multi-core structure. However, when considered together, both the computing processing apparatus and other processing apparatus may be regarded as forming a heterogeneous multi-core structure.

In one or a plurality of embodiments, other processing apparatus may serve as an interface that connects the computing processing apparatus (which may be embodied as an artificial intelligence computing apparatus such as a computing apparatus for a neural network operation) of the present disclosure to external data and control, perform basic controls that include but are not limited to moving data, starting and/or stopping the computing apparatus. In another embodiment, other processing apparatus may also cooperate with the computing processing apparatus to jointly complete an operation task.

In one or a plurality of embodiments, the interface apparatus may be used to transfer data and a control instruction between the computing processing apparatus and other processing apparatus. For example, the computing processing apparatus may obtain input data from other processing apparatus via the interface apparatus and write the input data to an on-chip storage apparatus (or called a memory) of the computing processing apparatus. Further, the computing processing apparatus may obtain the control instruction from other processing apparatus via the interface apparatus and write the control instruction to an on-chip control caching unit of the computing processing apparatus. Alternatively or optionally, the interface apparatus may further read data in the storage apparatus of the computing processing apparatus and then transfer the data to other processing apparatus.

Additionally or optionally, the combined processing apparatus of the present disclosure may further include a storage apparatus. As shown in figure, the storage apparatus may be connected to the computing processing apparatus and other processing apparatus respectively. In one or a plurality of embodiments, the storage apparatus may be used to store data of the computing processing apparatus and/or other processing apparatus. For example, the data may be data that may not be fully stored in an internal or the on-chip storage apparatus of the computing processing apparatus or other processing apparatus.

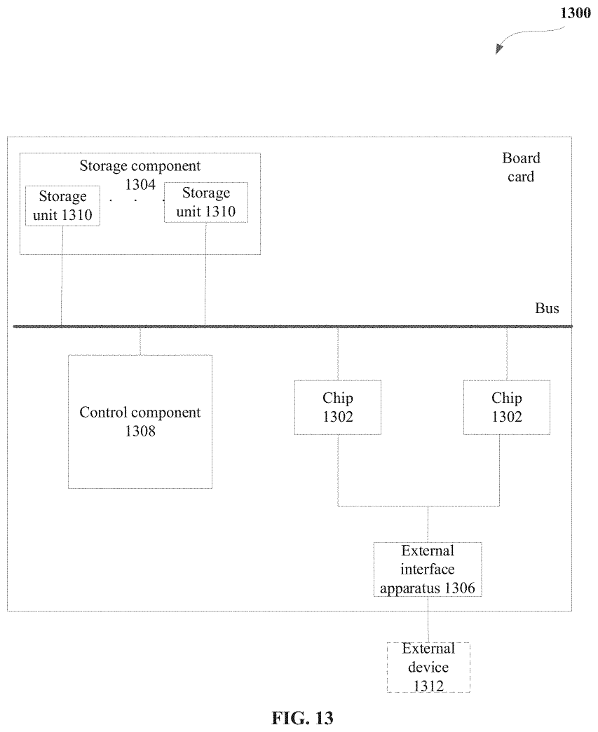

In some embodiments, the present disclosure also provides a chip (such as a chip 1302 shown in FIG. 13). In an implementation, the chip may be a system on chip (SoC) and may integrate one or a plurality of combined processing apparatuses shown in FIG. 12. The chip may be connected to other related components through an external interface apparatus (such as an external interface apparatus 1306 shown in FIG. 13). The related components may be, for example, a camera, a monitor, a mouse, a keyboard, a network card, or a WIFI interface. In some application scenarios, the chip may integrate other processing units (such as a video codec) and/or an interface unit (such as a dynamic random access memory (DRAM) interface), and the like. In some embodiments, the present disclosure provides a chip package structure, including the chip above. In some embodiments, the present disclosure provides a board card, including the chip package structure above. The following will describe the board card in detail in combination with FIG. 13.

FIG. 13 is a schematic structural diagram of a board card 1300 according to an embodiment of the present disclosure. As shown in FIG. 13, the board card may include a storage component 1304 for storing data, which may include one or a plurality of storage units 1310. The storage component may connect to and transfer data to a control component 1308 and the aforementioned chip 1302 through a bus. Further, the board card may include an external interface apparatus 1306, which may be configured to implement data relay or transfer between the chip (or the chip in the chip package structure) and an external device 1312 (such as a server or a computer, and the like). For example, to-be-processed data may be transferred from the external device to the chip through the external interface apparatus. For another example, a computing result of the chip may be still sent back to the external device through the external interface apparatus. According to different application scenarios, the external interface apparatus may have different interface forms. For example, the external interface apparatus may adopt a standard peripheral component interconnect express (PCIe) interface.

In one or a plurality of embodiments, the control component in the board card of the present disclosure may be configured to regulate and control a state of the chip. As such, in an application scenario, the control component may include a micro controller unit (MCU), which may be used to regulate and control a working state of the chip.

According to the aforementioned descriptions in combination with FIG. 12 and FIG. 13, those skilled in the art may understand that the present disclosure also provides an electronic device or apparatus, which may include one or a plurality of the aforementioned board cards, one or a plurality of the aforementioned chips, and/or one or a plurality of the aforementioned combined processing apparatuses.

According to different application scenarios, the electronic device or apparatus may include a server, a cloud-based server, a server cluster, a data processing device, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograph. The electronic device or apparatus of the present disclosure may be further applied to Internet, Internet of Things, data center, energy, transportation, public management, manufacturing, education, power grid, telecommunications, finance, retail, construction sites, medical and other fields. Further, the electronic device or apparatus of the present disclosure may be used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud-based device (such as the cloud-based server), while an electronic device or apparatus with low power consumption may be applied to a terminal-based device and/or an edge-based device (such as a smart phone or the webcam). In one or a plurality of embodiments, hardware information of the cloud-based device is compatible with that of the terminal-based device and/or the edge-based device. As such, according to hardware information of the terminal-based device and/or the edge-based device, appropriate hardware resources may be matched from hardware resources of the cloud-based device to simulate hardware resources of the terminal-based device and/or the edge-based device, so as to complete unified management, scheduling, and collaborative work of terminal-cloud integration or cloud-edge-terminal integration.

It is required to be explained that for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be executed in other orders or simultaneously. Further, those skilled in the art may understand that the embodiments described in the present disclosure may be regarded as optional embodiments; in other words, actions and modules involved thereof are not necessarily required for the implementation of a certain solution or some solutions of the present disclosure. Additionally, according to different solutions, descriptions of some embodiments of the present disclosure have their own emphases. In view of this, those skilled in the art may understand that for parts that are not described in detail in a certain embodiment of the present disclosure, reference may be made to related descriptions in other embodiments.

For specific implementations, according to the present disclosure and under the teaching of the present disclosure, those skilled in the art may understand that several embodiments disclosed in the present disclosure may be implemented through other methods that are not disclosed in the present disclosure. For example, for units in the electronic device or apparatus embodiment mentioned above, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the aforementioned direct or indirect coupling relates to a communication connection using an interface, where the communication interface may support electrical, optical, acoustic, magnetic, or other forms of signal transmission.

In the present disclosure, units described as separate components may or may not be physically separated. Components shown as units may or may not be a physical unit. The aforementioned components or units may be located in a same position or distributed to a plurality of network units. Additionally, according to actual requirements, some or all of the units may be selected for achieving the purpose of the solution described in embodiments of the present disclosure. Additionally, in some scenarios, a plurality of units in the embodiments of the present disclosure may be integrated into one unit, or each of the units may be physically separated.

In some implementation scenarios, the aforementioned integrated unit may be implemented in the form of a software program unit. If the integrated unit is implemented in the form of the software program unit and sold or used as an independent product, the integrated unit may be stored in a computer-readable memory. Based on such understanding, if the solution of the present disclosure is embodied in the form of a software product (such as a computer-readable storage medium), the software product may be stored in a memory, and the software product may include several instructions to be used to enable a computer device (which may be a personal computer, a server, or a network device, and the like) to perform part or all of steps of the method of the embodiments of the present disclosure. The foregoing memory may include but is not limited to an USB, a flash disk, a read only memory (ROM), a random access memory (RAM), a mobile hard disk, a magnetic disk, or an optical disc, and other media that may store a program code.

In some other implementation scenarios, the aforementioned integrated unit may be implemented in the form of hardware. The hardware may be a specific hardware circuit, which may include a digital circuit and/or an analog circuit. A physical implementation of a hardware structure of the circuit may include but is not limited to a physical component, and the physical component may include but is not limited to a transistor, or a memristor, and the like. In view of this, various apparatuses described in the present disclosure (such as the computing apparatus or other processing apparatus) may be implemented by an appropriate hardware processor, such as a central processing unit (CPU), a graphics processing unit (GPU), a field-programmable gate array (FPGA), a digital signal processor (DSP), and an application-specific integrated circuit (ASIC). Further, the aforementioned storage unit or storage apparatus may be any appropriate storage medium (including a magnetic storage medium or a magneto-optical storage medium, and the like), such as a resistive random access memory (RRAM), a dynamic random access memory (DRAM), a static random access memory (SRAM), an enhanced dynamic random access memory (EDRAM), a high bandwidth memory (HBM), a hybrid memory cube (HMC), ROM, and RAM, and the like.

The foregoing may be better understood according to following articles:

Article 1. A computing apparatus, including:
a processing circuit array, which is formed by connecting a plurality of processing circuits in a one-dimensional or multi-dimensional array structure, where the processing circuit array is configured to a plurality of processing circuit sub-arrays and perform a multi-thread operation in response to receiving a plurality of operation instructions, and each processing circuit sub-array is configured to perform at least one operation instruction in the plurality of operation instructions, where
the plurality of operation instructions are obtained by parsing a computing instruction received by the computing apparatus.

Article 2. The computing apparatus of article 1, an operation code of the computing instruction represents a plurality of operations performed by the processing circuit array, and the computing apparatus further includes a control circuit configured to acquire and parse the computing instruction to obtain a plurality of operation instructions corresponding to the plurality of operations represented by the operation code.

Article 3. The computing apparatus of article 2, where the control circuit configures the processing circuit array according to the plurality of operation instructions to obtain the plurality of processing circuit sub-arrays.

Article 4. The computing apparatus of article 3, where the control circuit includes a register used for storing configuration information, and the control circuit extracts corresponding configuration information according to the plurality of operation instructions and configures the processing circuit array according to the configuration information to obtain the plurality of processing circuit sub-arrays.

Article 5. The computing apparatus of article 1, where the plurality of operation instructions include at least one multi-stage pipeline operation, and the multi-stage pipeline operation includes at least two operation instructions.

Article 6. The computing apparatus of article 1, where the operation instruction includes a predicate, and each processing circuit judges whether to perform an associated operation instruction according to the predicate.

Article 7. The computing apparatus of article 1, where the processing circuit array is a one-dimensional array, and one or a plurality of processing circuits in the processing circuit array are configured to serve as one processing circuit sub-array.

Article 8. The computing apparatus of article 1, where the processing circuit array is a two-dimensional array, where
one or more rows of processing circuits in the processing circuit array are configured to serve as one processing circuit sub-array; or
one or more columns of processing circuits in the processing circuit array are configured to serve as one processing circuit sub-array; or
one or more rows of processing circuits along a diagonal direction of the processing circuit array are configured to serve as one processing circuit sub-array.

Article 9. The computing apparatus of article 8, where the plurality of processing circuits located in the two-dimensional array are configured to be connected in a predetermined two-dimensional interval mode with one or more of the remaining processing circuits in the same row, column, or diagonal in at least one of row, column, or diagonal directions of the plurality of processing circuits.

Article 10. The computing apparatus of article 9, where the predetermined two-dimensional interval mode is associated with the number of processing circuits spaced in the connection.

Article 11. The computing apparatus of article 1, where the processing circuit array is a three-dimensional array, and one or a plurality of three-dimensional sub-arrays in the processing circuit array are configured to serve as one processing circuit sub-array.

Article 12. The computing apparatus of article 11, where the three-dimensional array is a three-dimensional array composed of a plurality of layers, where each layer includes a two-dimensional array of a plurality of processing circuits arranged along row, column, and diagonal directions, where
a processing circuit located in the three-dimensional array is connected in a predetermined three-dimensional interval mode with one or more of the remaining processing circuits in the same row, column, diagonal, or a different layer in at least one of row, column, diagonal, and layer directions of the processing circuit.

Article 13. The computing apparatus of article 12, where the predetermined three-dimensional interval mode is associated with the number of intervals and the number of layers of intervals between to-be-connected processing circuits.

Article 14. The computing apparatus of any one of articles 7-13, where the plurality of processing circuits in the processing circuit sub-array are formed into one or a plurality of closed loops.

Article 15. The computing apparatus of article 1, where each processing circuit sub-array is suitable for performing at least one of following operations: an arithmetic operation, a logical operation, a comparison operation, and a lookup table operation.

Article 16. The computing apparatus of article 1, further including a data operating circuit, which includes a pre-operating circuit and/or a post-operating circuit, where the pre-operating circuit is configured to perform pre-processing on input data of at least one operation instruction, and the post-operating circuit is configured to perform post-processing on output data of at least one operation instruction.

Article 17. The computing apparatus of article 16, where the pre-processing includes data placement and/or lookup table operations, and the post-processing includes data type conversion and/or compression operations.

Article 18. The computing apparatus of article 17, where the data placement includes sending input data and/or output data of the operation instruction to corresponding processing circuits for operations after splitting or merging the input data and/or the output data of the operation instruction accordingly according to a data type of the input data and/or the output data of the operation instruction.

Article 19. An integrated circuit chip, including the computing apparatus of any one of articles 1-18.

Article 20. A board card, including the integrated circuit chip of article 19.

Article 21. An electronic device, including the integrated circuit chip of article 19.

Article 22. A method of using a computing apparatus to perform computing, where the computing apparatus includes a processing circuit array, which is formed by connecting a plurality of processing circuits in a one-dimensional or multi-dimensional array structure, and the processing circuit array is configured to a plurality of processing circuit sub-arrays, and the method includes:
receiving a computing instruction in the computing apparatus and parsing the computing instruction to obtain a plurality of operation instructions;
using the plurality of processing circuit sub-arrays to perform a multi-thread operation in response to receiving the plurality of operation instructions, where each processing circuit sub-array in the plurality of processing circuit sub-arrays is configured to perform at least one operation instruction in the plurality of operation instructions.

Article 23. The method of article 22, where an operation code of the computing instruction represents a plurality of operations performed by the processing circuit array, the computing apparatus further includes a control circuit, and the method includes using the control circuit to acquire and parse the computing instruction to obtain a plurality of operation instructions corresponding to the plurality of operations represented by the operation code.

Article 24. The method of article 23, where the control circuit is used to configure the processing circuit array according to the plurality of operation instructions to obtain the plurality of processing circuit sub-arrays.

Article 25. The method of article 24, where the control circuit includes a register used for storing configuration information, and the method includes using the control circuit to extract corresponding configuration information according to the plurality of operation instructions and configure the processing circuit array according to the configuration information to obtain the plurality of processing circuit sub-arrays.

Article 26. The method of article 22, where the plurality of operation instructions include at least one multi-stage pipeline operation, and the multi-stage pipeline operation includes at least two operation instructions.

Article 27. The method of article 22, where the operation instruction includes a predicate, and the method further includes using each processing circuit to judge whether to perform an associated operation instruction according to the predicate.

Article 28. The method of article 22, where the processing circuit array is a one-dimensional array, and the method includes configuring one or a plurality of processing circuits in the processing circuit array to serve as one processing circuit sub-array.

Article 29. The method of article 22, where the processing circuit array is a two-dimensional array, and the method further includes:
configuring one or more rows of processing circuits in the processing circuit array to serve as one processing circuit sub-array; or
configuring one or more columns of processing circuits in the processing circuit array to serve as one processing circuit sub-array; or
configuring one or more rows of processing circuits along a diagonal direction of the processing circuit array to serve as one processing circuit sub-array.

Article 30. The method of article 29, where the plurality of processing circuits located in the two-dimensional array are configured to be connected in a predetermined two-dimensional interval mode with one or more of the remaining processing circuits in the same row, column, or diagonal in at least one of row, column, or diagonal directions of the plurality of processing circuits.

Article 31. The method of article 30, where the predetermined two-dimensional interval mode is associated with the number of processing circuits spaced in the connection.

Article 32. The method of article 22, where the processing circuit array is a three-dimensional array, and the method includes configuring one or a plurality of three-dimensional sub-arrays in the processing circuit array to serve as one processing circuit sub-array.

Article 33. The method of article 32, where the three-dimensional array is a three-dimensional array composed of a plurality of layers, where each layer includes a two-dimensional array of a plurality of processing circuits arranged along row, column, and diagonal directions, and the method includes:
configuring a processing circuit located in the three-dimensional array to be connected in a predetermined three-dimensional interval mode with one or more of the remaining processing circuits in the same row, column, diagonal, or a different layer in at least one of row, column, diagonal, and layer directions of the processing circuit.

Article 34. The method of article 33, where the predetermined three-dimensional interval mode is associated with the number of intervals and the number of layers of intervals between to-be-connected processing circuits.

Article 35. The method of any one of articles 28-34, where the plurality of processing circuits in the processing circuit sub-array are formed into one or a plurality of closed loops.

Article 36. The method of article 22, where each processing circuit sub-array is suitable for performing at least one of following operations: an arithmetic operation, a logical operation, a comparison operation, and a lookup table operation.

Article 37. The method of article 1, further including a data operating circuit, which includes a pre-operating circuit and/or a post-operating circuit, and the method includes using the pre-operating circuit to perform pre-processing on input data of at least one operation instruction and/or using the post-operating circuit to perform post-processing on output data of at least one operation instruction.

Article 38. The method of article 37, where the pre-processing includes data placement and/or lookup table operations, and the post-processing includes data type conversion and/or compression operations.

Article 39. The method of article 38, where the data placement includes sending input data and/or output data of the operation instruction to corresponding processing circuits for operations after splitting or merging the input data and/or the output data of the operation instruction accordingly according to a data type of the input data and/or the output data of the operation instruction.

Although a plurality of embodiments of the present disclosure have been shown and described, it is obvious to those skilled in the art that such embodiments are provided only as examples. Those skilled in the art may conceive many modifying, altering, substituting methods without deviating from the thought and spirit of the present disclosure.

It should be understood that alternatives to the embodiments described herein may be employed in the practice of the present disclosure. The attached claims are intended to limit the scope of protection of the present disclosure and therefore to cover equivalents or alternatives within the scope of these claims.

1. A computing apparatus comprising:
a processing circuit array, which is formed by connecting a plurality of processing circuits in a one-dimensional or multi-dimensional array structure, wherein the processing circuit array is configured to a plurality of processing circuit sub-arrays and perform a multi-thread operation in response to receiving a plurality of operation instructions, and each processing circuit sub-array is configured to perform at least one operation instruction in the plurality of operation instructions,
wherein the plurality of operation instructions are obtained by parsing a computing instruction received by the computing apparatus.

2. The computing apparatus of claim 1, wherein an operation code of the computing instruction represents a plurality of operations performed by the processing circuit array, and the computing apparatus further comprises a control circuit configured to acquire and parse the computing instruction to obtain a plurality of operation instructions corresponding to the plurality of operations represented by the operation code.

3. The computing apparatus of claim 2, wherein the control circuit configures the processing circuit array according to the plurality of operation instructions to obtain the plurality of processing circuit sub-arrays.

4. The computing apparatus of claim 3, wherein the control circuit comprises a register used for storing configuration information, and the control circuit extracts corresponding configuration information according to the plurality of operation instructions and configures the processing circuit array according to the configuration information to obtain the plurality of processing circuit sub-arrays.

5. The computing apparatus of claim 1, wherein the plurality of operation instructions comprise at least one multi-stage pipeline operation, and the multi-stage pipeline operation comprises at least two operation instructions.

6. The computing apparatus of claim 1, wherein the operation instruction comprises a predicate, and each processing circuit judges whether to perform an associated operation instruction according to the predicate.

7. The computing apparatus of claim 1, wherein the processing circuit array is a one-dimensional array, and one or a plurality of processing circuits in the processing circuit array are configured to serve as one processing circuit sub-array.

8. The computing apparatus of claim 1, wherein the processing circuit array is a two-dimensional array,
wherein one or more rows of processing circuits in the processing circuit array are configured to serve as one processing circuit sub-array; or
one or more columns of processing circuits in the processing circuit array are configured to serve as one processing circuit sub-array; or
one or more rows of processing circuits along a diagonal direction of the processing circuit array are configured to serve as one processing circuit sub-array.

9. The computing apparatus of claim 8, wherein the plurality of processing circuits located in the two-dimensional array are configured to be connected in a predetermined two-dimensional interval mode with one or more of the remaining processing circuits in the same row, column, or diagonal in at least one of row, column, or diagonal directions of the plurality of processing circuits.

10. The computing apparatus of claim 9, wherein the predetermined two-dimensional interval mode is associated with the number of processing circuits spaced in the connection.

11. The computing apparatus of claim 1, wherein the processing circuit array is a three-dimensional array, and one or a plurality of three-dimensional sub-arrays in the processing circuit array are configured to serve as one processing circuit sub-array.

12. The computing apparatus of claim 11, wherein the three-dimensional array is a three-dimensional array composed of a plurality of layers, wherein each layer comprises a two-dimensional array of a plurality of processing circuits arranged along row, column, and diagonal directions,
wherein a processing circuit located in the three-dimensional array is configured to be connected in a predetermined three-dimensional interval mode with one or more of the remaining processing circuits in the same row, column, diagonal, or a different layer in at least one of row, column, diagonal, and layer directions of the processing circuit.

13. The computing apparatus of claim 12, wherein the predetermined three-dimensional interval mode is associated with the number of intervals and the number of layers of intervals between to-be-connected processing circuits.

14. The computing apparatus of claim 7, wherein the plurality of processing circuits in the processing circuit sub-array are formed into one or a plurality of closed loops.

15. The computing apparatus of claim 1, wherein each processing circuit sub-array is suitable for performing at least one of following operations: an arithmetic operation, a logical operation, a comparison operation, and a lookup table operation.

16. The computing apparatus of claim 1, further comprising a data operating circuit, which comprises a pre-operating circuit and/or a post-operating circuit,
wherein the pre-operating circuit is configured to perform pre-processing on input data of at least one operation instruction, and the post-operating circuit is configured to perform post-processing on output data of at least one operation instruction.

17. The computing apparatus of claim 16, wherein the pre-processing comprises data placement and/or lookup table operations, and the post-processing comprises data type conversion and/or compression operations.

18. The computing apparatus of claim 17, wherein the data placement comprises sending input data and/or output data of the operation instruction to corresponding processing circuits for operations after splitting or merging the input data and/or the output data of the operation instruction accordingly according to a data type of the input data and/or the output data of the operation instruction.

19. An integrated circuit chip, comprising the computing apparatus of claim 1.

20. (canceled)

21. (canceled)

22. A method of using a computing apparatus to perform computing, wherein the computing apparatus comprises a processing circuit array, which is formed by connecting a plurality of processing circuits in a one-dimensional or multi-dimensional array structure, and the processing circuit array is configured to a plurality of processing circuit sub-arrays, the method comprising:
receiving a computing instruction in the computing apparatus and parsing the computing instruction to obtain a plurality of operation instructions; and
using the plurality of processing circuit sub-arrays to perform a multi-thread operation in response to receiving the plurality of operation instructions,
wherein each processing circuit sub-array in the plurality of processing circuit sub-arrays is configured to perform at least one operation instruction in the plurality of operation instructions.

23-39. (canceled)
